(19) United States
(12) Patent Application Publication
(10) Pub. No.: US 2009/0220924 A1
(43) Pub. Date: Sep. 3, 2009

(54) Device for visually associating categorized product features, and associated method

(75) Inventors: Claire Smith, Royaume (GB); Eric Chatry, Bois Colombes (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: MOET HENNESSY

(21) Appl. No.: 12/074,379

(22) Filed: Mar. 3, 2008

(51) Int. Cl. G09B 19/00

(52) U.S. Cl. 434/127

(57) ABSTRACT

A device for visually associating categorized product features, comprising:
a base (10) having a generally flat surface, and keying arrangements (1000),
a readable pattern (102) of categorized feature indicia (1021) in a zone (100) associated with the keying arrangements,
a set of transparent sheets (20a, 20b, . . . ) respectively associated to a plurality of products, each sheet having a keying arrangements (2000) complementary to those of the base, so that it can be placed over the readable pattern only in a given orientation, and each transparent sheet including a specific arrangement of semi-transparent zones (201a, 202a, . . . ; 201b, 202b, . . . ) adapted to register with product feature indicia (1021), whereby at least two transparent sheets corresponding to different products can be superimposed and their feature indicia visually highlighted by being seen through their respective semi-transparent zones.

The present invention generally relates to a device for presentation of categorized features or characteristics of products such as beverage products.

### BACKGROUND OF THE INVENTION

The art of cocktail creation is a sophisticated one.

Typically, a barman or cocktail designer tries to experiment mixtures of different beverages with different dosages, and his own taste as well as the taste of consumer (or a test panel) is relied upon to identify interesting mixture.

Such process is generally lengthy and tedious, in view of the very large number of available beverages, whether alcoholic or non-alcoholic, and the wide variety of flavors and aromas contained in such beverages.

In other words, a great number of tries is necessary before reaching an interesting beverage mixture or cocktail.

There are currently no tools available to assist in mixing together flavors and aromas except the knowledge of the barman or cocktail designer about the different tastes of the different available products, knowledge essentially acquired by experience or in some manner by manuals or tutorials focused on cocktail creation.

### SUMMARY OF THE INVENTION

The present invention aims at providing a device that can give useful guidance to mixing or combining products having identified product features, without however limiting the creativity involved in such activity.

To this end, the present invention provides according to a first aspect a device for visually associating categorized product features, comprising:
a base having a generally flat surface, and keying arrangements,
a readable pattern of categorized feature indicia in a zone associated with the keying arrangements,
a set of transparent sheets respectively associated to a plurality of products, each sheet having a keying arrangements complementary to those of the base, so that it can be placed over the readable pattern only in a given orientation, and each transparent sheet including a specific arrangement of semi-transparent zones adapted to register with product feature indicia, whereby at least two transparent sheets corresponding to different products can be superimposed and their feature indicia visually highlighted by being seen through their respective semi-transparent zones.

In this manner, the user can immediately determine how flavors/aromas contained in different products will positively combine together, oppose each other, conflict with each other, neutralize each other, etc.

Advantageously, the keying arrangements of the base are a recess

In a preferred embodiment, the body is an essentially rigid cover of a binder-type article, said article further comprising a set of pockets for the respective transparent sheets. In this manner, the device may keep the advantages of cocktail books or the like, with which cocktail designers may be familiar with, and in particular include in the binder all kinds of literature and illustrations about the different products to which the transparent sheets correspond.

Most preferably, said readable pattern of categorized features comprises a hierarchy of features arranged in a concentric pattern of zones. This allows to cover in an endless loop fashion all ranges of categories of flavors/aromas, to that mutual contribution or opposition between different products can be easily perceived by the user.

In such case, the hierarchy preferably comprises basic feature categories arranged in a center circular zone, feature subcategories arranging in an intermediate ring-shaped zone and feature designations arranged in a peripheral ring-shaped zone.

Advantageously, the keying arrangements of the base comprise a contour of a recess at the bottom of the readable pattern of categorized feature indicia is formed, and the keying arrangements on the transparent sheets are defined by a corresponding contour of the edges of said sheets.

In a further advantageous embodiment, said contour comprises a major generally circular portion having a center which is common with the center of the concentric pattern, and a minor non-circular portion.

Therefore, a keying effect is achieved in a simple manner while providing the user-friendly feeling of superimposed wheels.

In such case, the semi-transparent zones are circular sectors extending from said center. In this manner, all three of the category, the sub-category and the flavor(s)/aroma(s) are designated by a semi-transparent zone.

Preferably, the transparent sheets include groups of sheets whose semi-transparent zones have different colors, said groups corresponding to product categories. In such case, an additional visual indication is provided to the user when thinking about mixing together products from different product categories (e.g. Champagne, whiskeys, vodkas, etc.).

The device may also include a set of blank transparent sheets having the same keying contour but essentially deprived from semi-transparent zones. In this manner, the user can use a permanent marker for applying semi-transparent ink to such a blank sheet, corresponding to a product that is not already encompassed by the provided transparent sheets with semi-transparent zones.

The device of the present invention applies particularly well to beverage products for cocktail creation, said features being beverage flavors and/or aromas.

In yet another advantageous embodiment, the device further comprises a computer-readable data carrier comprising:
a set of digital images comprising a representation of a readable pattern of categorized features at the bottom of the recess and representations of a plurality of transparent sheets with their semi-transparent zones,
a computer program allowing to generate for display purposes a combined representation of said readable pattern of categorized features and of previously selected transparent sheets.

In this manner, the user can either use hardware items of the device, of their software equivalents. For instance, by a drag-and-drop technique, the user can selectively perform the software equivalent as physically bringing the transparent sheets over the category indicia.

The present invention additionally provides a method for designing product mixtures such are drinking cocktails, comprising selecting transparent sheets of a device according to any one of claims 1 to 11 so that when fitted in the recess of said device, said semi-transparent zones of said sheets are highlighting product features that mutually combine in a desired manner.

Finally, the present invention provides a method for promoting products, comprising:
providing a representation of a readable pattern of categorized feature indicia of products,
providing a set of representations of transparent sheets respectively associated to a plurality of said products and each having a specific arrangement of semi-transparent zones adapted to register with product feature indicia of said readable pattern representation,
selecting at least one transparent sheet representation,
arranging said selected transparent sheet representation(s) in a given orientation relative to said readable pattern representation, whereby at least two transparent sheet representations corresponding to different products can be superimposed and their feature indicia visually highlighted by being seen through their respective semi-transparent zones,
   whereby said products comprise generic products and products to be promoted, and the method further comprising:
when a transparent sheet representation corresponding to a given generic product is selected, suggesting a transparent sheet representation corresponding to a product to be promoted which is similar to said given generic product.

It should be noted here that the above method can be implemented either in hardware form with a device e.g. as defined above, of in software form e.g. by using the computer-readable data carrier as defined above, or similar data stored in a computer.

Again, the products are advantageously beverages, with said features being beverage flavors and/or aromas, and the products to be promoted are those supplied by one same beverage company or group.

### BRIEF DESCRIPTION OF THE DRAWINGS

The present invention will be more clearly understood from the following detailed description of a preferred embodiment thereof, made with reference to the appended drawings, in which:

FIG. 1 is a perspective view diagrammatically illustrating a device according to the present invention,

FIG. 2 shows an example of marking of feature indicia comprised in the device,

FIGS. 3 and 4 illustrate two examples of transparent sheets comprised in the device of the present invention, and

FIGS. 5 and 6 illustrate the combination of the feature indicia with one transparent sheet and two transparent sheets, respectively.

### DETAILED DESCRIPTION OF A PREFERRED EMBODIMENT

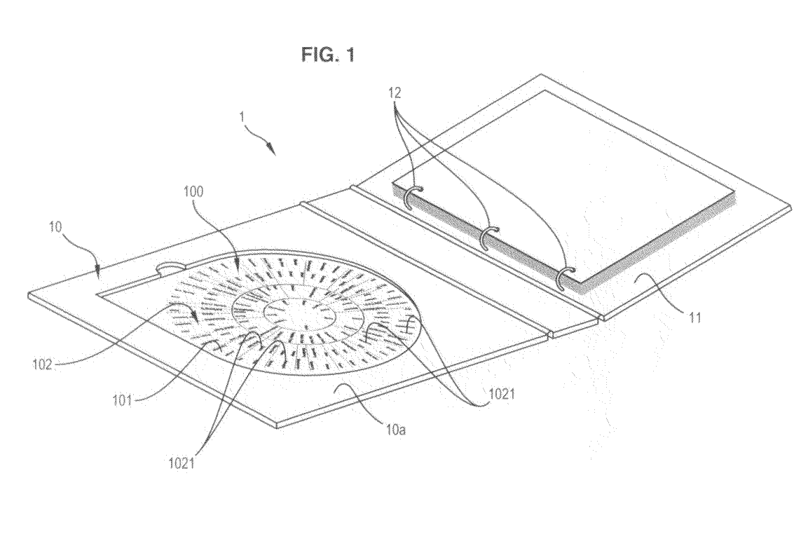

Now referring to FIG. 1, the device of the present invention comprises in the present example a binder-like article 1 comprising a front cover 10, a back cover 11 and a set of rings 12 for receiving a set of printed pages and pockets as will be described later.

The inside face 10a of the front cover 10 comprises a recess 100 having a depth of typically 0.5 to 5 mm having a specific non-circular contour 1000.

In the present example, the shape of the recess contour 1000 is similar to a water drop shape, and can be seen as three quarters of a circle (portion 1001) combined with two sides of a square (portion 1002), the side of which is the same length as the circle radius.

The bottom 101 of the recess has a pattern 102 of product feature indicia 1021 arranged on it, e.g. formed by printing.

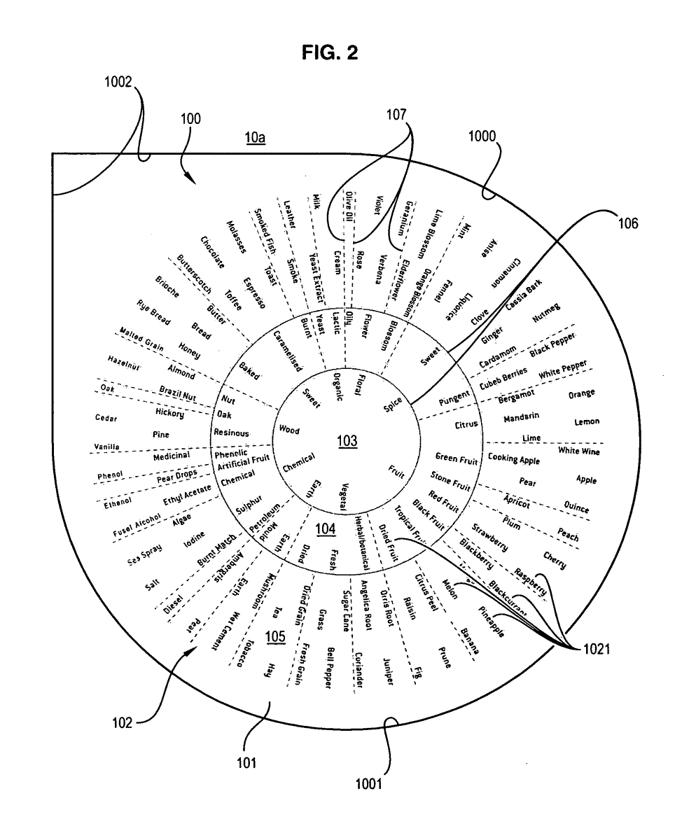

An exemplary form of this pattern of product feature indicia is shown in detail in FIG. 2.

It comprises a central circular zone 103 with basic flavor or aroma categories (here chemical, earth, vegetal, fruit, spice, floral, organic, sweet, wood), a intermediate ring-shaped zone 104 with, for each category, a set of sub-categories as shown, and an outer ring-shaped zone 105 with, for each sub-category, individual aroma or flavor indicia.

The three zones 103, 104 and 105 are separated from each other by continuous circular lines 106, while the basic categories are separated from each other by dashed lines 107 extending radially in zones 104 and 105.

The categories, sub-categories and individual flavors and aromas are to be considered as belonging to the present description.

They are the result of an extensive categorization work by specialists, and their innovative arrangement in an endless or loop fashion (here in a circular pattern) is part of the present invention.

The device of the present invention further comprises a set of transparent sheets, preferably made of a synthetic flexible material such as polyester.

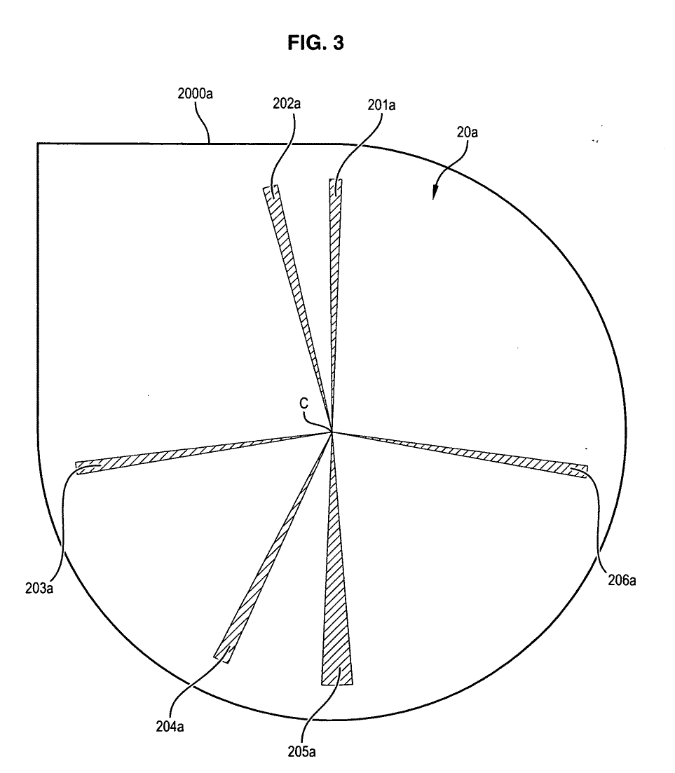

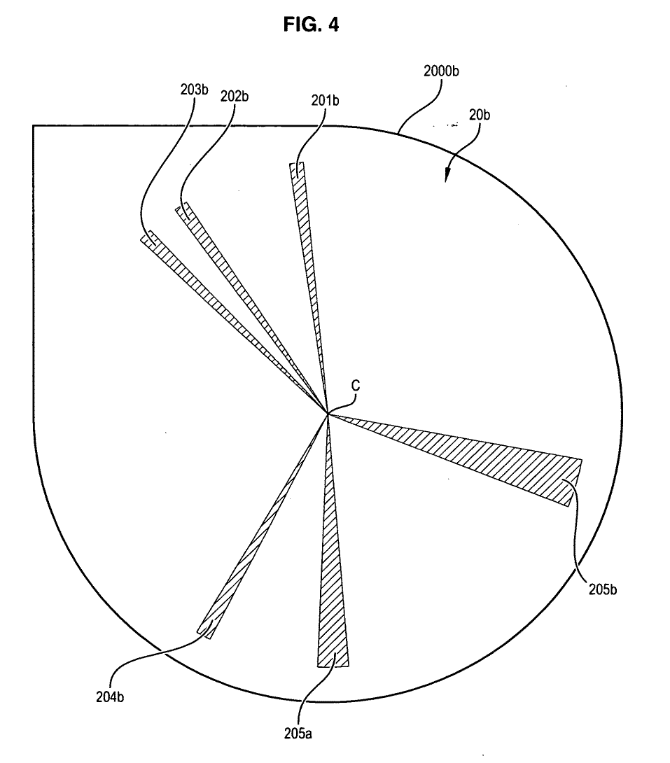

Two examples of such transparent sheets are illustrated in FIGS. 3 and 4. As shown each sheet, respectively 20a, 20b, includes one or several semi-transparent zones, respectively 201a, 202a, etc. and 201b, 202b, etc. each having the shape of an angular sector of a circle extending from a center C of the sheet.

Preferably, each semi-transparent zone is made by printing with a light color or semi-transparent ink so that highly contrasted markings such as those of indicia 1021 printed at the recess bottom will remain clearly readable through these zones.

Each sheet further comprises appropriate marking identifying the product to which it corresponds (product (a) for sheet 20a, product (b) for sheet 20b, etc.), for instance printed along an edge thereof so as not to interfere with the semi-transparent zones.

Preferably, when the products are categorized in groups or families,

Each sheet 20a, 20b, etc. has a contour edge respectively 2000a, 2000b, etc. such that it can tightly fit in the recess 100 of the binder cover 10 only when it has a predetermined angular orientation. In other words, the contour of recess 100 combined with the contour of the transparent sheets 20a, 20b, etc. act as a keying system ensuring a predetermined mutual position between the pattern 102 of indicia 1021 printed at the bottom of the recess and the semi-transparent zones of the sheets.

Of course, any other arrangements suitable for ensuring a proper keying effect between the printed indicia 1021 on cover 10 or other suitable base and the transparent sheets 20a, 20b, etc. can be used. For instance, the cover can include a continuous rib or a set of ribs extending around the pattern zone. In another embodiment, pin and hole registration can be used, etc.

When a user wants to determine what flavors/aromas are contained in a given product, he places the corresponding transparent sheet (here the sheet 20a) in recess 100, in the proper orientation as dictated by edges 1000, 2000a.

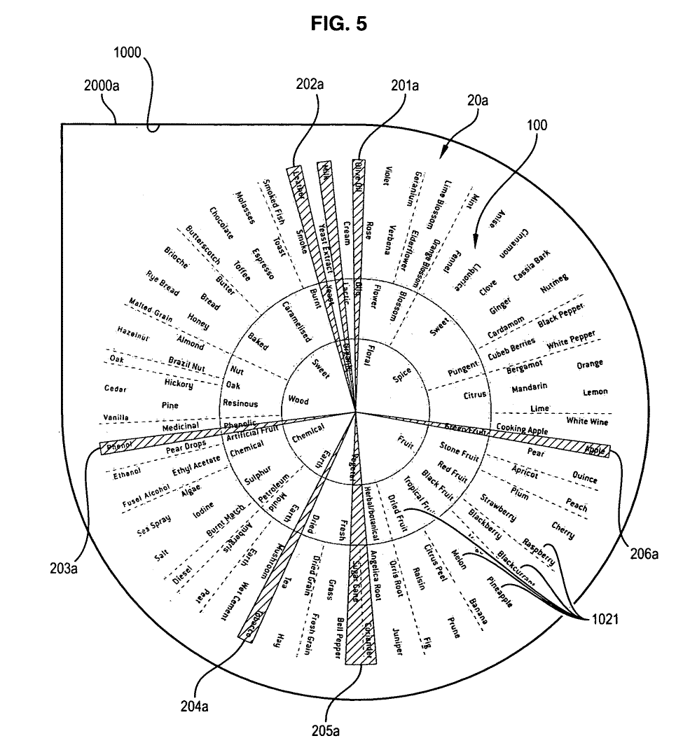

In this position, and as illustrated in FIG. 5, each semi-transparent zone 201a, 202a, 203a, etc. of the sheet covers one or more specific feature indicia 1021 of the product. As can be seen, a basic narrow sector zone such as 201a or 202a registers with one single feature indicia arranged radially in the pattern. A wider sector zone 205a can cover two or even more feature indicia.

Thus the user can immediately perceive the different flavor/aroma components of a product when observing the superposition of the pattern 102 and the corresponding transparent sheet (sheet 20a for product (a) in the present species), as shown in FIG. 5.

Now if the user wants to perceive how this particular product (a) would combine with another product (b), he leaves sheet 20a in the recess and adds on top of it another sheet (sheet 20b in the present species) corresponding to said product (b).

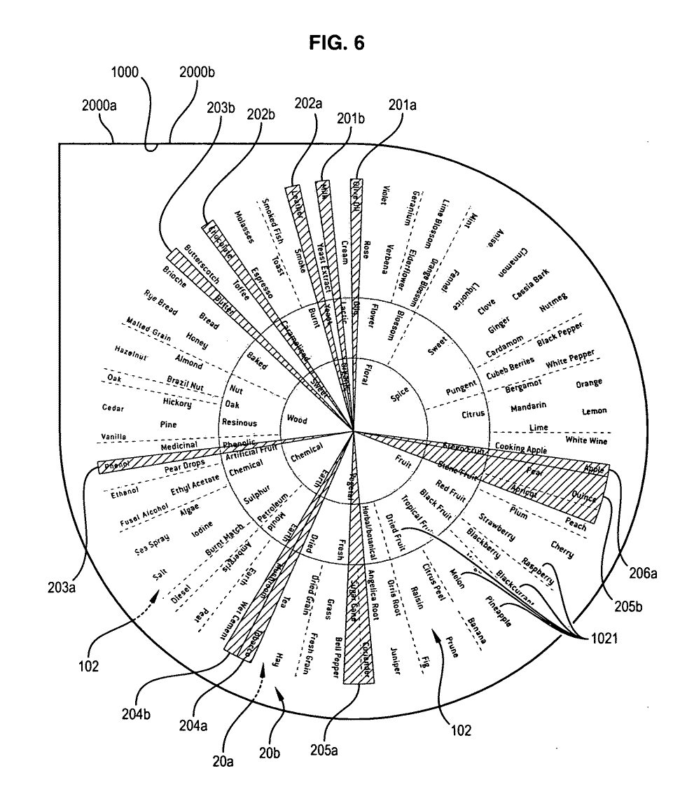

The corresponding situation is illustrated in FIG. 6. As can be seen, some zones (such as zone 201b reveals a feature of the second product (b) that is located just between two features identified by zones 201a, 202a of the first product (a), which can either be desirable (the mixture is reinforced in this category of features) or undesirable (the mixture would be too complex in terms of aromas/flavors in this range).

It can also be seen that zone 204b which designates two adjacent features of the second product (b) partially overlaps with the zone 204a identifying one of said features for the first product (a). This reveals a reinforcement of the common feature in the mixture, which can be desirable or not.

In still another manner, it can be seen that zone 205b designating three adjacent features of the second product (b) is located just adjacent zone 206a identifying a feature of the first product (a). This again means a reinforcement in this category of features, which can be either desirable or undesirable.

The user, depending on the perceived results of the combination of two given sheets, can either remove one sheets or the two sheets, and start another combination process, or add a third sheet corresponding to a third product to determine how it would combine with the two others. A fourth product, or even more products, can again be added to the combination.

Thus, by means of such comparisons, the user can choose the product that matches his taste, replace a product with similar features in a specific cocktail, or create new cocktails.

Typically, a device of the present invention will include several tens of transparent sheets corresponding to the same number of products, which gives rise to an extremely high number of possible combinations.

According to another aspect of the present invention, and in a manner not illustrated, the binder 10 can include in an appropriate receptacle, for a computer-readable data carrier such as CR-ROM or DVD-ROM.

This data carrier comprises digital images of appropriate resolution forming representations of the pattern 102 of feature indicia 1021 and of the transparent sheets 20a, 20b, etc., as well as an appropriate computer program.

This program allows, via a suitable user input device such as a mouse and/or keyboard, to select one or more of the images of transparent sheets corresponding to given products, and to superimpose, by known techniques of image combination such as layering, these images with the pattern image, so as to obtain by software a similar visual effect as the one obtained with the “hardware” comprised of base 10 and pattern 102 of feature indicia and transparent sheets 20a, 20b, etc.

This additional software version allows huge possibilities such as suggesting mixtures, either by random or guided choice, and providing detailed product information and suggestions for combination each time a product is selected by the computer program.

From the above indications, the skilled person will easily design and write a computer program fulfilling the described functions.

Of course, the present invention can have multiple variants and additions.

For instance, the device can be embodied as any type article, whether a binder or book type or not, provided that it has a generally flat base for the pattern of indicia, and a set of transparent sheets.

In addition, blank transparent sheets can be provided, possibly together with a set of markers or pens capable of applying a semi-transparent ink thereon. In this manner, the user can create personalized transparent sheets, e.g. corresponding to his own taste impressions for additional products.

Another use of the present invention is the promotion of a given group of products, e.g. the range of beverages sold by a given beverage company or group.

In this case, there can be transparent sheets (or their software representations) both for generic products and for the products to be promoted. Each time a transparent sheet representation of a generic product is used, a suggestion of the transparent sheet representation of a product to be promoted which is similar to the generic product is proposed or suggested (e.g. by signs on the hardware transparent sheet of the generic product or by a computer-generated message in the software implementation of the invention.

A “similar” product can be, in the case of cocktail mixtures, a product that is close enough to the generic product so as not to change the nature or designation of the cocktail (e.g. a branded vodka instead of a generic vodka, with slightly different flavors/aromas), or product that is more remote from the generic product, so as to facilitate the creation of new cocktails based on branded products.

Finally, the use of the present invention is not limited to the creation of cocktails, but can encompass a large variety of applications where products, articles, services, etc. each having specific features that can compare to each other, may be combined in different ways or replaced by one another. Non limiting examples are the creation of culinary recipes, perfumes, artistic works, etc.

1. A device for visually associating categorized product features comprising:
a base having a generally flat surface and keying arrangements;
a readable pattern of categorized feature indicia in at least one zone associated with the keying arrangements; and
a set of transparent sheets associated with a plurality of products, each sheet having a keying arrangement complementary to the keying arrangement of the base and having an arrangement of semi-transparent zones adapted to register with the feature indicia, wherein at least two transparent sheets corresponding to different products can be superimposed and the feature indicia can be seen through the semi-transparent zones.

2. A device according to claim 1, wherein the base is binder-type article, the article comprising a set of pockets for the transparent sheets.

3. A device according to claim 1, wherein the readable pattern of categorized feature indicia comprises a hierarchy of features arranged in a concentric pattern of zones.

4. A device according to claim 3, wherein the hierarchy comprises basic feature categories arranged in a center circular zone, feature subcategories arranged in an intermediate ring-shaped zone and feature designations arranged in a peripheral ring-shaped zone.

5. A device according to claim 1, wherein the keying arrangements of the base comprise a recessed contour a bottom of the readable pattern of categorized feature indicia and the keying arrangements the transparent sheets comprise a corresponding contour.

6. A device according to claim 5, wherein the contour comprises a substantially circular portion having a center which is common with a center of a concentric pattern and a non-circular portion.

7. A device according to claim 6, wherein the semi-transparent zones are circular sectors extending radially from the center.

8. A device according to claim 1, wherein the transparent sheets include groups of sheets having semi-transparent zones having different colors.

9. A device according to claim 8, wherein the groups of sheets correspond to product categories.

10. A device according to claim 1, further comprising a set of blank transparent sheets having a keying contour and being devoid of semi-transparent zones.

11. A device according to claim 1, wherein the categorized product features are beverage flavors or aromas.

12. A device according to claim 1, further comprising a computer-readable data carrier comprising:
a set of digital images comprising a representation of a readable pattern of categorized features at the bottom of a recess and representations of a plurality of transparent sheets having semi-transparent zones; and
a computer program for generating a combined representation of the readable pattern of categorized feature indicia and any of the transparent sheets.

13. A method for designing product mixtures such as drinking cocktails comprising:
selecting transparent sheets of a device according to claim 1;
fitting the semi-transparent zones of the sheets in a recess of the device; and
highlighting combinations of product features.

14. A method for promoting products comprising:
providing a representation of a readable pattern of categorized feature indicia of the products;
providing a set of representations of transparent sheets associated with a plurality of the products, each sheet having a specific arrangement of semi-transparent zones adapted to register with the feature indicia of the readable pattern representation;
selecting at least one transparent sheet representation; and
arranging the selected transparent sheet representation in a given orientation relative to said readable pattern representation, wherein at least two transparent sheet representations corresponding to different products are superimposed and the feature indicia are visually highlighted through the semi-transparent zones.

15. A method according to claim 14, wherein the products are beverages and the categorized feature indicia are beverage flavors or aromas.

16. The method of claim 14, wherein the products comprise generic products and products to be promoted.

17. The method of claim 14, further comprising:
selecting a transparent sheet representation corresponding to a generic product thereby suggesting a transparent sheet representation corresponding to a product to be promoted which is similar to a generic product.
